(19) United States
(12) Patent Application Publication
(10) Pub. No.: US 2012/0095607 A1
(43) Pub. Date: Apr. 19, 2012

(54) Method, Apparatus, and System for Energy Efficiency and Energy Conservation Through Dynamic Management of Memory and Input/Output Subsystems

(76) Inventors: Ryan D. Wells, Folsom, CA (US); Avinash N. Ananthakrishnan, Hillsboro, OR (US); Inder Sodhi, Folsom, CA (US); Eric C. Samson, Folsom, CA (US); Joydeep Ray, Folsom, CA (US)

(21) Appl. No.: 13/335,638

(22) Filed: Dec. 22, 2011

(51) Int. Cl. G06F 1/26

(52) U.S. Cl. 700/291

(57) ABSTRACT

According to one embodiment of the invention, an integrated circuit device comprises an interconnect, at least one compute engine and a control unit. Coupled to the at least one compute engine via the interconnect, the control unit to analyze heuristic information from the at least one compute engine and to increase or decrease a bandwidth of the interconnect based on the heuristic information.

### FIELD

Embodiments of the invention pertain to energy efficiency and energy conservation in integrated circuits, as well as code to execute thereon, and in particular but not exclusively, to an integrated circuit device that is adapted to dynamically manage power and performance of memory and input/output (I/O) subsystems within an electronic device.

### GENERAL BACKGROUND

Advances in semiconductor processing and logic design have permitted an increase in the amount of logic that may be present on integrated circuit devices. As a result, computer system configurations have evolved from a single or multiple integrated circuits in a system to multiple hardware threads, multiple cores, multiple devices, and/or complete systems on individual integrated circuits. Additionally, as the density of integrated circuits has grown, the power requirements for computing systems (from embedded systems to servers) have also escalated. Furthermore, software inefficiencies, and its requirements of hardware, have also caused an increase in computing device energy consumption. In fact, some studies indicate that computing devices consume a sizeable percentage of the entire electricity supply for a country, such as the United States of America. As a result, there is a vital need for energy efficiency and conservation associated with integrated circuits. These needs will increase as servers, desktop computers, notebooks, ultrabooks, tablets, mobile phones, processors, embedded systems, etc. become even more prevalent (from inclusion in the typical computer, automobiles, and televisions to biotechnology).

As general background, processors include a variety of logic circuits fabricated on different power planes of a semiconductor integrated circuit (IC). These logic circuits are collectively coupled to a common interconnect, sometimes referred to as the “ring,” which is an interconnect extends across one of the power planes featuring one or more processor cores. Considered part of an I/O subsystem as well as a memory subsystem, the ring interconnect supports the transmission of data and control between various circuitry within an IC. For instance, the ring interconnect provides a coupling between the processor cores and I/O subsystem components. The ring interconnect also provides a coupling between the graphics logic and components of the memory subsystem such as cache memory.

Currently, processor cores are adapted to operate in a plurality of operating modes. The first operating mode supports operations up to a guaranteed frequency (TDP frequency). The “TDP frequency” is a frequency at which the processor will run, under normal operating conditions, within the established “Thermal Design Power” (TDP). The “TDP” is a power constraint that identifies the maximum amount of power that an electronic device implemented with the processor is required to dissipate.

The second operating mode, sometimes referred to as “Turbo” mode, enables the processor cores within the processor to exceed the guaranteed (TDP) frequency, given that a processor rarely operates in worst case conditions.

As a result, the ring interconnect is tuned to operate at a certain operating frequency (e.g., 2 gigahertz “GHz”) in order support the transmission of data at a high data rate when the processor cores are operating in the second (Turbo) operating mode. Conversely, when the processor cores are inactive and/or running well below the TDP frequency due to a reduced workload, the ring interconnect is tuned to operate at a reduced frequency (e.g., 800 megahertz “MHz”), a frequency that provides sufficient bandwidth to support the reduced workload.

While reducing the operating frequency of the ring interconnect enables the electronic device to achieve power savings, it also creates a potential architectural issue. Namely, when the processor cores are running at a low frequency/voltage due to minimal workload (<<1 GHz), the ring interconnect will likely operate as a limiter because, by operating at a low frequency/voltage, it will not be able to provide sufficient bandwidth for fetching data from cache memory and/or system memory if the graphics logic is operating at a high operating frequency (e.g., 1.5 GHz). As a result, the graphics logic will not be able to perform at its intended performance level. Likewise, setting an artificially high operating ring frequency needlessly wastes power.

Static control of the operating frequency of the ring interconnect (e.g., setting ring frequency at boot time) does not address the ongoing workload changes that constantly occur, where some workload conditions may warrant frequency reduction of the ring interconnect while others do not.

### BRIEF DESCRIPTION OF THE DRAWINGS

The invention may best be understood by referring to the following description and accompanying drawings that are used to illustrate embodiments of the invention.

FIG. 1 is an exemplary block diagram of an electronic device implemented with an integrated circuit device featuring dynamic memory and input/output management.

FIG. 2 is a first exemplary block diagram of the system architecture implemented within the electronic device of FIG. 1 or another electronic device.

FIG. 3 is a second exemplary block diagram of the system architecture implemented within the electronic device of FIG. 1 or another electronic device.

FIG. 4 is a first exemplary block diagram of the packaged integrated circuit device with dynamically adjustable operational controls in accordance with workload by one or more processor cores or a graphics core.

FIG. 5 is an exemplary block diagram of intercommunications between the PCU implemented within the system agent unit of FIG. 4 and one or more I/O subsystems.

FIG. 6 is an exemplary embodiment of intercommunications between the PCU implemented within the system agent unit of FIG. 4 and a memory subsystem over a plurality of memory channels.

FIG. 7 is an exemplary embodiment of a dynamic energy manager that adjusts operational controls for either the I/O subsystem or memory subsystem.

FIG. 8 is an exemplary block diagram of a control unit configured to control performance of the targeted subsystem (I/O, memory, etc.) based on heuristic information from compute engine(s).

FIG. 9 is a second exemplary block diagram of the integrated circuit device that includes a controller adapted to monitor feedback from different internal compute engines in order to dynamically adjust certain operational controls in accordance with the workload of the compute engine(s).

FIG. 10 is an exemplary block diagram of the electronic device in which a controller with the device is adapted to monitor feedback from different compute engines is implemented on a circuit board in order to dynamically adjust certain operational controls for an I/O or memory subsystem.

FIG. 11 is an exemplary flowchart of the operations conducted for dynamic power and performance management of I/O and/or memory subsystems.

### DETAILED DESCRIPTION

Herein, certain embodiments of the invention relate to an integrated circuit device that includes a control unit to analyze heuristic information from at least one or more compute engines and to dynamically control power and/or performance of a targeted subsystem (e.g., an input/output “I/O” subsystem and/or a memory subsystem) based on the heuristic information.

For instance, as an illustrative embodiment, a control unit within an integrated circuit device may be adapted to analyze heuristic information from different compute engines within the integrated circuit device that are coupled to an interconnect (e.g., ring interconnect) in order to determine if any of the compute engines is “memory bound”. When at least one of the compute engines is determined to be memory bound, the frequency associated with the interconnect will be increased. Otherwise, the frequency of the interconnect may be maintained or even decreased for power saving purposes.

The term “memory bound” indicates a condition where requests for stored data are not being fulfilled within a suitable time period. This can be measured by implementing logic (e.g., counters) that monitors various performance parameters attributed to the electronic device such as, for example, the following: (1) the number of outstanding memory requests awaiting handling; (2) a rate increase of the outstanding memory requests (e.g., number of outstanding memory requests has increased x % over a predetermined time period); or (3) the number of clock cycles that a compute engine was waiting on data to come back.

As another illustrative embodiment, the control unit of the integrated circuit device may be adapted to analyze heuristic information from at least one or more compute engines within the integrated circuit device in order to determine if performance adjustments should be conducted for the memory subsystem. Accordingly, where compute engines have a reduced workload, the control unit may reduce performance (e.g. transmitted bit rate, latency, etc.) of the memory subsystem, for example, by reducing the operating frequency of system memory (e.g. double data rate “DDR” Random Access Memory, Synchronous Dynamic Random Access Memory, or another type memory) or reducing the number of channels supported by interfaces for system memory, or reducing a data width of an internal data path to system memory (hereinafter referred to as the “memory interconnect”).

In general terms, one embodiment of the invention is directed to the adjustment of voltage and/or frequency provided to an I/O subsystem or a memory subsystem to match bandwidth needs of a compute engine such as a processor compute engine or a graphics compute engine. As described above, this may involve increasing or decreasing the bandwidth provided by the ring interconnect in order to match the bandwidth needed by the graphics compute engine. Alternatively, this may involve increasing or decreasing the frequency of (or adjusting the number of channels utilized by) the memory interconnect.

Although the following embodiments are described with reference to energy conservation and energy efficiency in specific integrated circuits, such as in electronic devices or processors, other embodiments are applicable to other types of integrated circuits and devices. Similar techniques and teachings of embodiments described herein may be applied to other types of circuits or semiconductor devices that may also benefit from better energy efficiency and energy conservation.

In the following description, certain terminology is used to describe features of the invention. For example, the term “integrated circuit device” generally refers to any integrated circuit or collection of integrated circuits that operate at a selected frequency to process information, and the selected frequency is limited to ensure correct operations of the device. Examples of an integrated circuit device may include, but are not limited or restricted to a processor (e.g. a single or multi-core microprocessor, a digital signal processor “DSP”, or any special-purpose processor such as a network processor, co-processor, graphics processor, embedded processor), a microcontroller, an application specific integrated circuit (ASIC), a memory controller, an input/output (I/O) controller, or the like.

Both terms “logic” and “unit” may constitute hardware and/or software. As hardware, logic (or unit) may include circuitry, semiconductor memory, combinatorial logic, or the like. As software, the logic (or unit) may be one or more software modules, such as executable code in the form of an executable application, an application programming interface (API), a subroutine, a function, a procedure, an object method/implementation, an applet, a servlet, a routine, a source code, an object code, firmware, a shared library/dynamic load library, or one or more instructions.

It is contemplated that these software modules may be stored in any type of suitable non-transitory storage medium or transitory computer-readable transmission medium. Examples of non-transitory storage medium may include, but are not limited or restricted to a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive. Examples of transitory storage medium may include, but are not limited or restricted to electrical, optical, acoustical or other form of propagated signals such as carrier waves, infrared signals, and digital signals.

The term “interconnect” is broadly defined as a logical or physical communication path for information. Therefore, the interconnect is formed using any communication medium such as a wired physical medium (e.g., a bus, one or more electrical wires, trace, cable, etc.) or a wireless medium (e.g., air in combination with wireless signaling technology).

A “compute engine” is generally defined as a collection of logic that is adapted to receive and process data. The term “heuristic information” is generally defined as feedback, normally count values from counters assigned to monitor certain performance parameters, that provides information related to the current operations of a device. For instance, heuristic information may include, but is not limited or restricted to the number of cache hits/misses, the number of outstanding memory requests, the number of memory reads/writes/commands initiated, a current voltage level, a current frequency level, latency for a request (load) or response, the number of stalled cycles, or the like.

Lastly, the terms “or” and “and/or” as used herein are to be interpreted as an inclusive or meaning any one or any combination. Therefore, the phrases “A, B or C” and “A, B and/or C” mean any of the following: A; B; C; A and B; A and C; B and C; A, B and C. An exception to this definition will occur only when a combination of elements, functions, steps or acts are in some way inherently mutually exclusive.

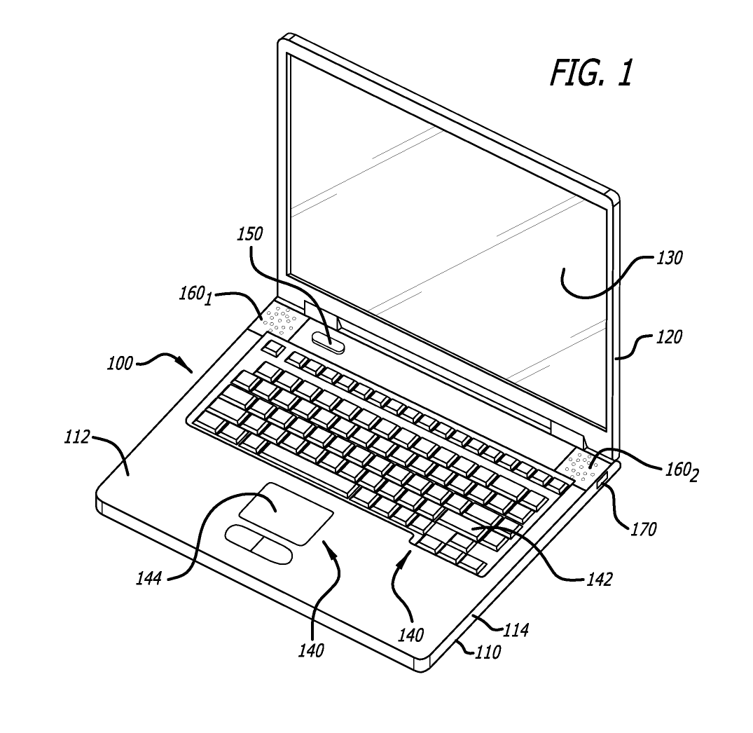

Referring now to FIG. 1, an exemplary block diagram of an electronic device 100 is shown. Electronic device 100 comprises one or more integrated circuit devices that perform heuristic-based analysis of integral subsystems with variable operational controls (e.g., I/O subsystem of device 100, memory subsystem of device 100, etc.). These operational controls (e.g., frequency, voltage, state, and/or latency) may be used to adjust subsystem performance in response to bandwidth needs for at least one or more compute engine(s) within electronic device 100.

Herein, electronic device 100 is realized, for example, as a notebook-type personal computer. However, it is contemplated that electronic device 100 may be a cellular telephone, any portable computer including a tablet computer, a desktop computer, a television, a set-top box, a video game console, a portable music player, a personal digital assistant (PDA), or the like.

As shown in FIG. 1, electronic device 100 includes a housing 110 and a display unit 120. According to this embodiment of the invention, display unit 120 includes a liquid crystal display (LCD) 130 which is built into display unit 120. According to one embodiment of the invention, display unit 120 may be rotationally coupled to housing 110 so as to rotate between an open position where a top surface 112 of housing 110 is exposed, and a closed position where top surface 112 of housing 110 is covered. According to another embodiment of the invention, display unit 120 may be integrated into housing 110.

Referring still to FIG. 1, housing 110 may be configured as a thin box-shaped housing. According to one embodiment of the invention, an input device 140 is disposed on top surface 112 of housing 110. As shown, input device 140 may be implemented as a keyboard 142 and/or a touch pad 144. Although not shown, input device 140 may be touch-screen display 130 that is integrated into housing 110, or input device 140 may be a remote controller if electronic device 100 is a television.

Other features include a power button 150 for powering on/off electronic device and speakers 160₁ and 160₂ disposed on top surface 112 of housing 110. At a side surface 114 of housing 110 is provided a connector 170 for downloading and uploading information. According to one embodiment, connector 170 is a Universal Serial Bus (USB) connector although another type of connector may be used.

As an optional feature, another side surface of electronic device 100 may be provided with high-definition multimedia interface (HDMI) terminal which support the HDMI standard, a DVI terminal or an RGB terminal (not shown). The HDMI terminal and DVI terminal are used in order to receive or output digital video signals with an external device.

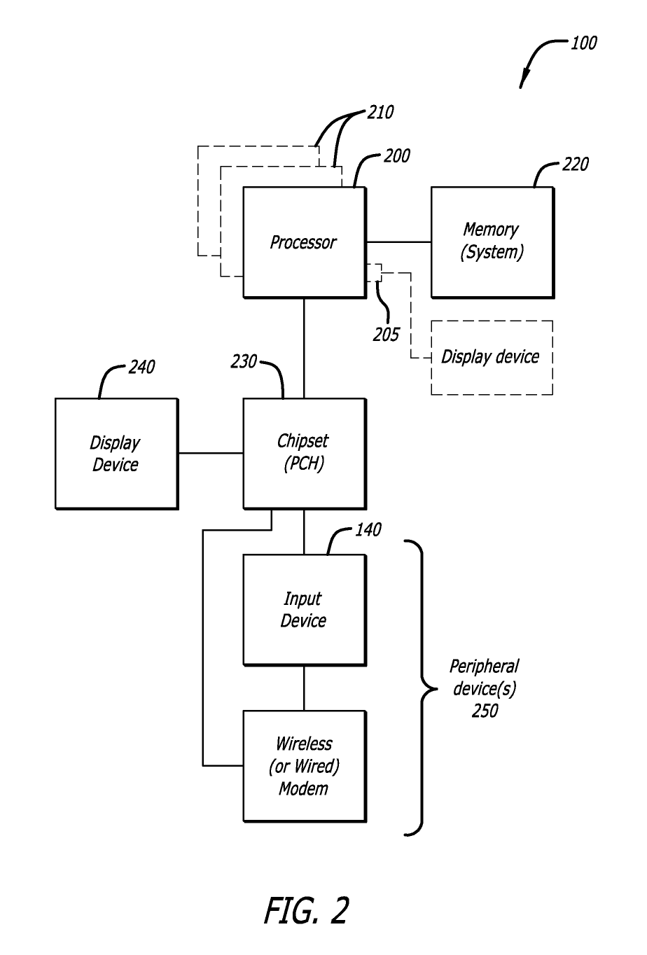

Referring now to FIG. 2, a first exemplary block diagram of the system architecture implemented within electronic device 100 of FIG. 1 is shown. Herein, electronic device 100 comprises one or more processors 200 and 210. Processor 210 is shown in dashed lines as an optional feature as electronic device 100 may be adapted with a single processor as described below. Any additional processors, such as processor 210, may have the same or different architecture as processor 200 or may be an element with processing functionality such as an accelerator, field programmable gate array (FPGA), or the like.

Herein, processor 200 comprises an integrated memory controller (not shown), and thus, is coupled to memory 220 (e.g., non-volatile or volatile memory such as a double data rate static random access memory “DDR SRAM”). Furthermore, processor 200 is coupled to a chipset 230 (e.g., Platform Control Hub “PCH”) which may be adapted to control interaction between processor(s) 200 and 210 and memory 220 and incorporates functionality for communicating with a display device 240 (e.g., integrated LCD) and peripheral devices 250 (e.g., input device 140 of FIG. 1, wired or wireless modem, etc.). Of course, it is contemplated that processor 200 may be adapted with a graphics controller (not shown) so that display device 240 may be coupled to processor 200 via a Peripheral Component Interconnect Express (PCI-e) port 205 as represented by dashed lines.

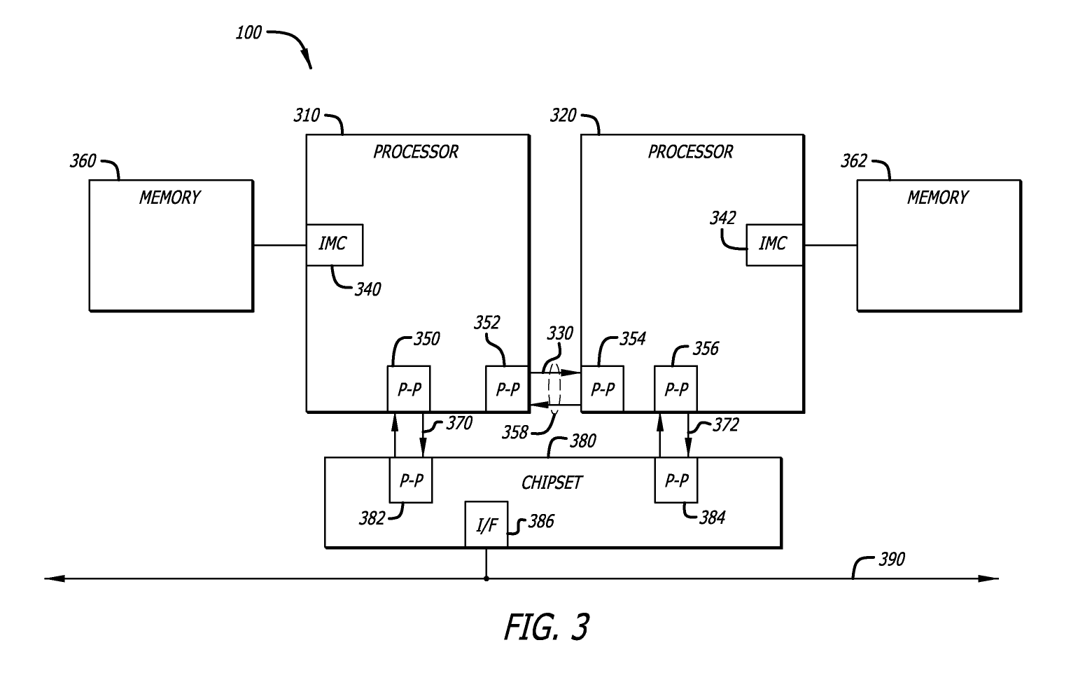

Referring now to FIG. 3, a second exemplary block diagram of the system architecture implemented within electronic device 100 of FIG. 1 is shown. Herein, electronic system 100 is a point-to-point interconnect system, and includes first processor 310 and second processor 320 coupled via a point-to-point (P-P) interconnect 330. As shown, processors 310 and/or 320 may be some version of processors 200 and/or 210 of FIG. 2, or alternatively, processor 310 and/or 320 may be an element other than a processor such as an accelerator or FPGA.

First processor 310 may further include an integrated memory controller hub (IMC) 340 and P-P circuits 350 and 352. Similarly, second processor 320 may include an IMC 342 and P-P circuits 354 and 356. Processors 310 and 320 may exchange data via a point-to-point (P-P) interface 358 using P-P circuits 352 and 354. As further shown in FIG. 3, IMC 340 and IMC 342 couple processors 310 and 320 to their respective memories, namely memory 360 and memory 362, which may be portions of main memory locally attached to respective processors 310 and 320.

Processors 310 and 320 may each exchange data with a chipset 380 via interfaces 370 and 372 using P-P circuits 350, 382, 356 and 384. Chipset 380 may be coupled to a first bus 390 via an interface 386. In one embodiment, first bus 395 may be a Peripheral Component Interconnect Express (PCI-e) bus or another third generation I/O interconnect bus, although the scope of the present invention is not so limited.

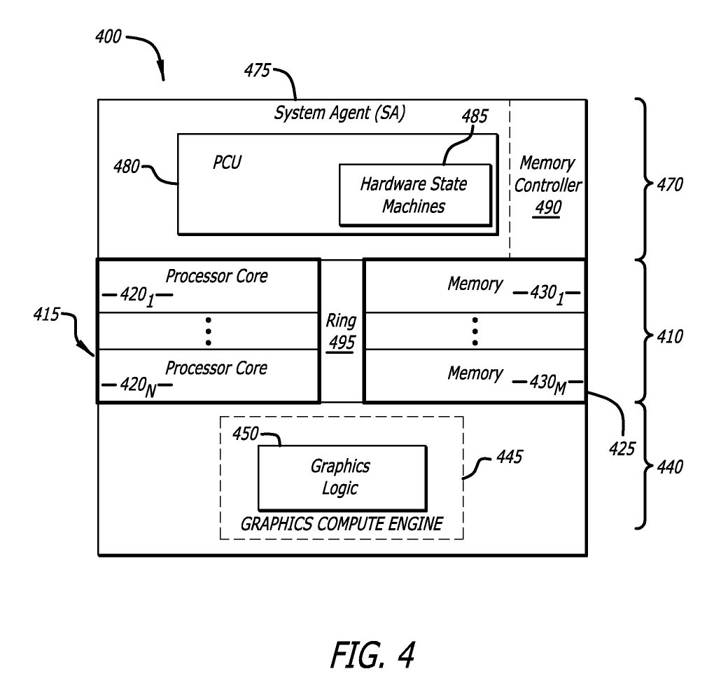

Referring to FIG. 4, an exemplary block diagram of an integrated circuit device 400, which includes a control unit adapted to monitor feedback from different internal compute engines in order to dynamically adjust certain operational controls in accordance with the workload of the compute engine(s), is shown. Herein, integrated circuit device 400 may be multi-core processor 200 of FIG. 2. However, it is contemplated that integrated circuit device 400 may be implemented as another type of processor (e.g. single-core processor, DSP, etc.), an accelerator, FPGA, or the like.

More specifically, as shown in FIG. 4, integrated circuit device 400 comprises a plurality of power planes 410, 440 and 470. The voltage and/or frequency applied to components on these power planes can be increased or decreased to adjust the overall performance of the electronic device. As a result, the electronic device can be controlled to operate at the most efficient power point. Ring interconnect 495 supports data and control transmissions between components within power planes 410, 440 and 470, and effectively, it is part of the variable memory and/or I/O subsystem.

In general, first power plane 410 features components with variable voltages and/or frequencies. Herein, first power plane 410 includes a processor compute engine 415 that comprises a plurality of processor cores 420₁-420_{N} (N≧1), which are in communication with ring interconnect 495. The voltage and/or frequency of each processor cores 420₁-420_{N} can be adjusted. Additionally, first power plane 410 further includes a portion of memory subsystem 425 that is also in communication with ring interconnect 495. Memory subsystem 425 comprises, inter alia, a plurality of on-chip memories 430₁-430_{M} (M≧1) that are coupled to processor cores 420₁-420_{N}. These on-chip memories 430₁-430_{M} may be last-level caches (LLCs) each corresponding to one of the processor cores 420₁-420_{N}.

Herein, bandwidth of ring interconnect 495 may be dynamically adjusted by increasing or decreasing its operating frequency based on heuristic information provided by processor core(s) 420₁, . . . , or 420_{N} in response to changes in workload.

As further shown in FIG. 4, second power plane 440 features a graphics compute engine 445 that comprises graphics logic 450 and is in communication with ring interconnect 495. Second power plane 440, which supports the variation of voltage and/or frequency applied to components implemented thereon, is controlled independently from voltage and frequency changes applied to first power plane 410.

Coupled to ring interconnect 495, a system agent (SA) may be implemented on third power plane 470 that supports the application of a fixed voltage and frequency. According to one embodiment of the invention, SA 475 comprises a power control unit (PCU) 480, hardware state machines 485, and an integrated memory controller 490.

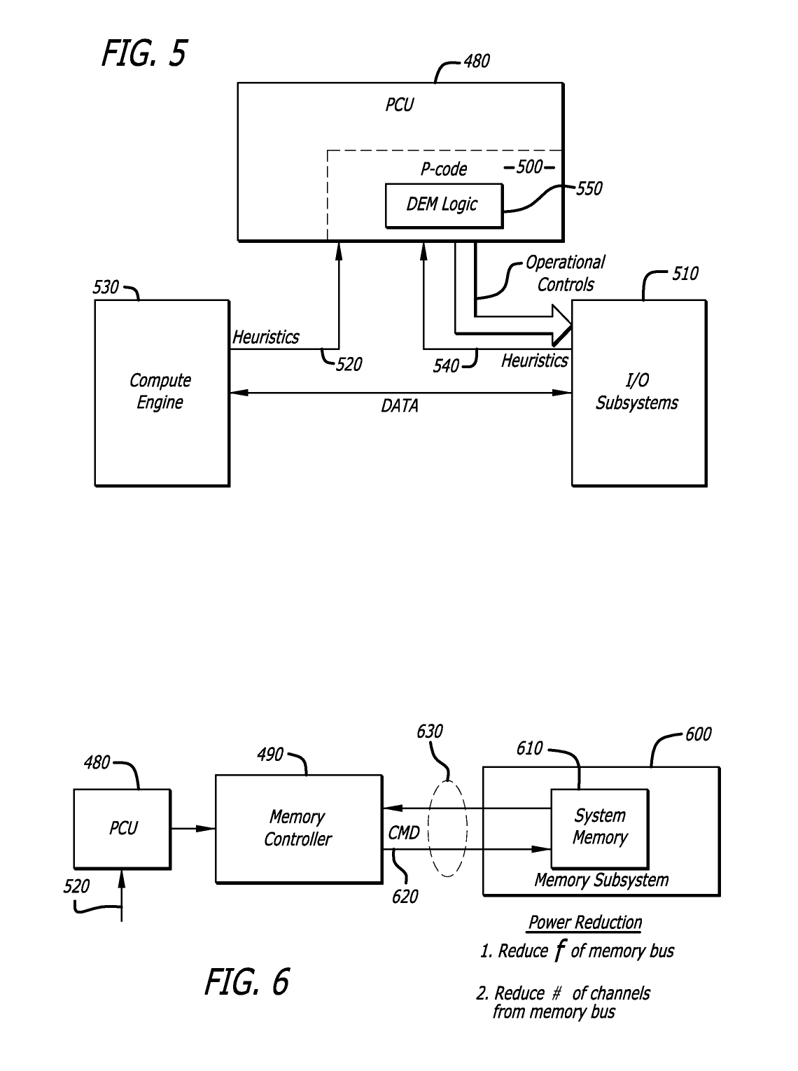

A hybrid of hardware and firmware, PCU 480 is a control unit that manages operational controls for various integrated subsystems (e.g., memory subsystem, or I/O subsystem) utilized by integrated circuit device 400. As shown in FIGS. 4 and 5, PCU 480 includes a micro-controller that runs firmware (P-code) 500 for managing operational controls for various integrated subsystems, such as I/O subsystem 510 for example, using heuristic information 520 received from compute engine(s) 530 (e.g., processor compute engine 415, graphics compute engine 445, etc.) and perhaps heuristic information 540. More specifically, dynamic energy manager (DEM) logic 550 within P-code 500, when executed, is adapted to analyze heuristic information 520 and/or 540 and, where appropriate, adjust the operational controls for I/O subsystem 510 based on workload needs by compute engine(s) 530.

For instance, based on heuristic information from graphics compute engine 445, PCU 480 may retain the bandwidth (and operating frequency) of ring interconnect 495 even through workload from processor compute engine 415 has drastically reduced.

Referring still to FIGS. 4-6, hardware state machines 485 are adapted to control the transitioning in voltage and frequency for power planes 440 and 470 and integrated memory controller 490 is implemented within SA 475 to adjust performance of memory subsystem 600. In particular, by PCU 480 adjusting the settings of memory controller 490 based on heuristic information 520 from compute engine(s) 530, PCU 480 may cause memory controller 490 to (i) change the operating frequency and/or voltage realized for system memory (e.g. double data rate “DDR” random access memory) 610, (ii) reduce the number of communication channels utilized between memory controller 490 and system memory 610 or (iii) scale memory performance and power.

In order to reduce the operating frequency and/or voltage applied to system memory 600, in response to signaling from PCU 480, memory controller 490 issues a command 620 to system memory 610 via memory interconnect 630 to alter its memory power state. For example, by specific setting one or more specific registers (not shown) within system memory 610, the operating frequency of system memory 610 may be reduced or increased, thereby adjusting the performance and power usage of memory subsystem 600 in response to heuristic information provided from compute engine(s) 530.

It is contemplated that, by deactivating one of the communication channels provided by memory interconnect 630, performance and power usage may be substantially reduced. Such deactivation may be useful where access to stored data is less frequent and the bandwidth supplied by the reduced number of communication channels is sufficient to meet the workload demand.

It is further contemplated that certain types of memory, such as DRAM support a mode called “CKE Power-down”. There are 3 different types of CKE power-down modes that can be utilized to trade-off performance and power dynamically; namely CKE Power-down off, Precharge Powerdown DLL ON, and Precharge Powerdown DLL Off. Each of these modes, in the above-identified order, will save more power in the DRAM but give less performance. Based on the memory performance state, memory controller 490 will dynamically choose a power-friendly or performance-friendly mode.

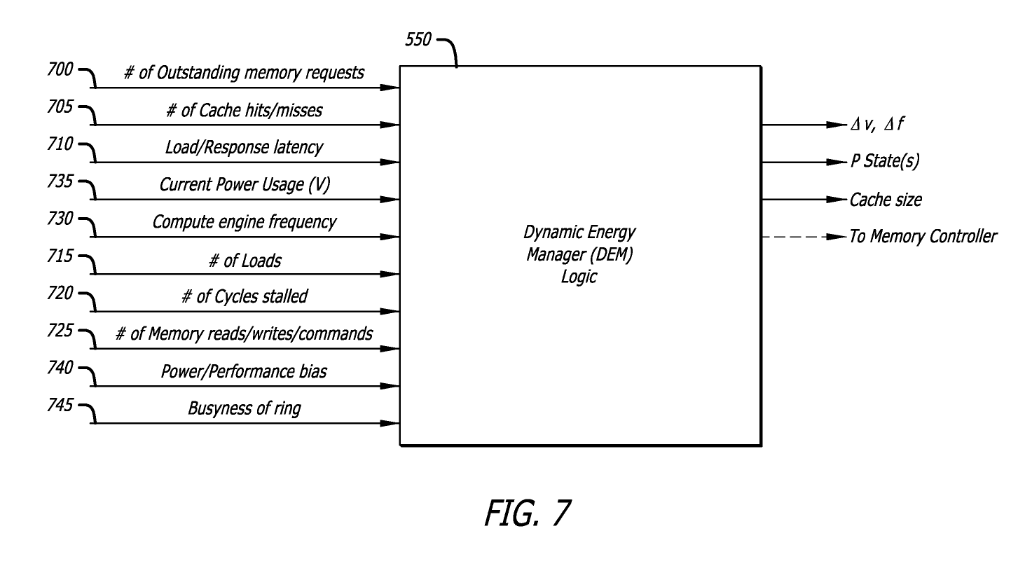

Referring now to FIG. 7, an exemplary embodiment of inputs that may be utilized by dynamic energy manager logic 550 within P-code 500 to adjust the operational controls for I/O subsystem 510 and/or I/O memory subsystem 600. These heuristic information inputs include one or more of the following:
1) number of outstanding memory requests 700;
2) number of cache hits or misses 705;
3) response time latency 710;
4) number of load instructions 715;
5) number of cycles stalled for load processing 720;
6) number of memory reads, writes or commands 725;
7) compute engine frequency 730;
8) compute engine power usage 735;
9) power/performance bias 740 (user or OS specific preference for how to balance high performance with power savings; and
10) busyness of ring interconnect 745

Referring still to FIG. 7, based on some or all of the heuristic information inputs, dynamic energy manager logic 550 adjusts power and performance of various subsystems. Such adjustments may be accomplished by altering power states (frequency/voltage) of these subsystems, altering frequency or channel distribution for interconnects being part of these subsystems, altering cache size (and hence power usage), scaled memory and performance through memory settings, and the like.

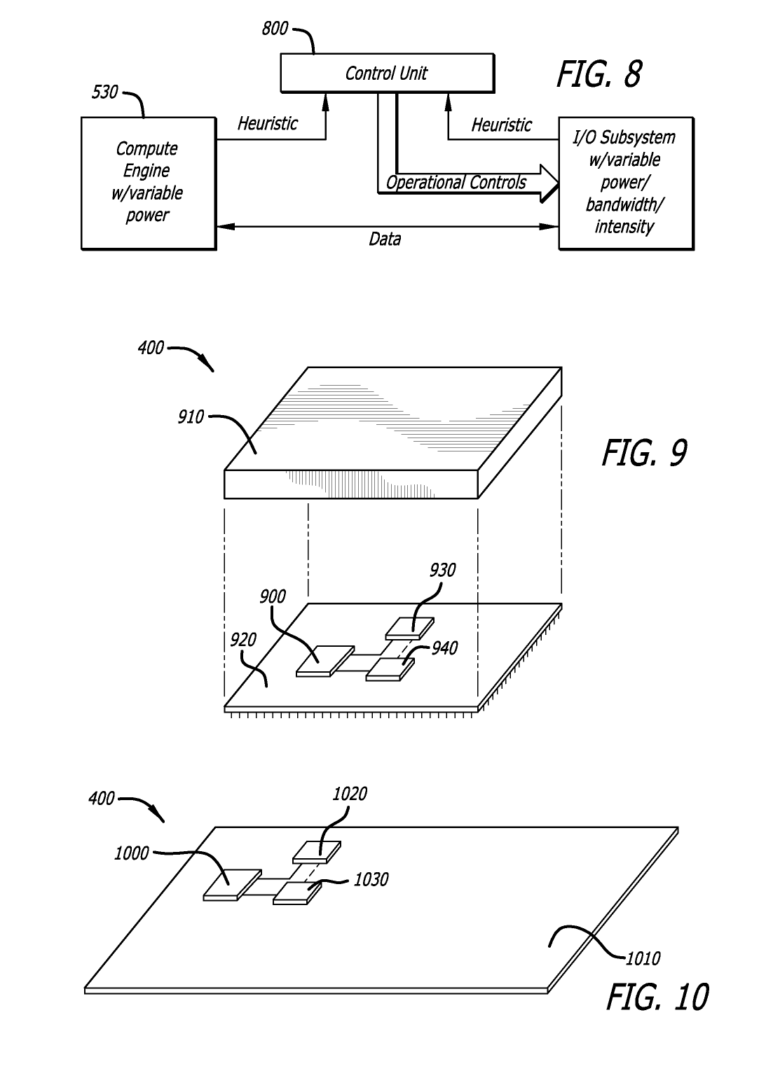

It is contemplated that, in lieu of utilizing PCU 480, it is contemplated that another type of control unit 800 may be utilized to control performance of the targeted subsystem (I/O, memory, etc.) based on heuristic information from compute engine(s) 530 as shown in FIG. 8.

Referring now to FIG. 9, a second exemplary block diagram of integrated circuit device 400, which includes a controller 900 adapted to monitor feedback from different internal compute engines in order to dynamically adjust certain operational controls in accordance with the workload of the compute engine(s), is shown. Herein, integrated circuit device 400 includes a package 910 partially or fully encapsulating a substrate 920. Substrate 820 comprises a controller 900 that is adapted to alter the operational controls for component(s) 930 of memory subsystem or component(s) 940 of I/O subsystem based on heuristic information supplied by compute engines, which may be located on the same integrated circuit as controller or on a different integrated circuit. Hence, controller 900 performs the above-described operations of the PCU implemented in accordance with the integrated circuit (die) architecture shown in FIG. 4.

Referring to FIG. 10, an exemplary block diagram of electronic device 100 is shown, where a controller 1000 for monitoring feedback from different compute engines is implemented on a circuit board 1010 in order to dynamically adjust certain operational controls for an I/O subsystem and/or a memory subsystem. Components of I/O subsystem and/or a memory subsystem are also located on circuit board 1010. Herein, controller 1000 is mounted on circuit board 1010 and, based on heuristic information supplied by one or more compute engines on circuit board 1010, adjusts power and performance of components 1020 and 1030 for I/O and memory subsystems at different locations on circuit board 1010. Hence, controller 1000 performs the above-described operations of the PCU implemented in accordance with the integrated circuit (die) architecture shown in FIG. 4.

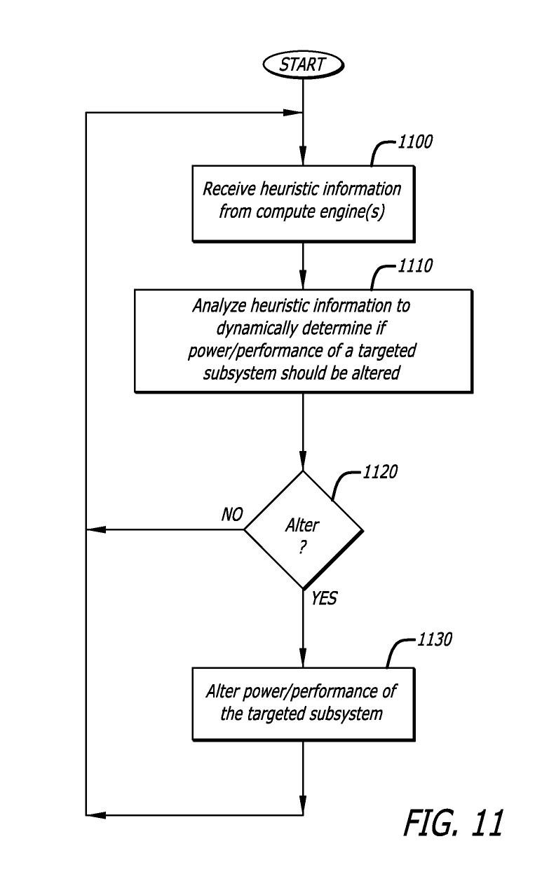

Referring now to FIG. 11, an exemplary flowchart of the operations conducted for dynamic power and performance management of I/O and memory subsystems is shown. According to one embodiment of the invention, these operations may be conducted by the integrated circuit device to control subsystems within its package.

First, heuristic information from compute engines is received by a control unit (block 1100). According to one embodiment of the invention, the control unit may be implemented within the same packaged integrated circuit device as the compute engines. According to another embodiment of the invention, the control unit is in a separate integrated circuit device than the compute engines.

Next, the control unit analyzes the heuristic information to determine, in a dynamic manner, if power and/or performance of a targeted subsystem should be altered (block 1110). Such analysis may involve the control unit determining if the compute engine is memory bound. Alternatively, such analysis may involve the control unit determining if performance of the memory subsystem should be reduced based on the workload (or current frequency/voltage levels) of one or more of the compute engines. For instance, if both the processor and graphics compute engines are operating at a low power/frequency level due to reduced workload, the control unit may determine that the memory subsystem performance should be reduced through reduction in cache size (e.g., inactivate one of the LLC caches, etc.), reduce the operating frequency of the system memory, or reduce the bandwidth of the memory interconnect.

Thereafter, alter or retain the power and performance of the target subsystem and continue analysis of heuristic information to allow for dynamic adjustment of power and performance of the memory and/or I/O subsystems (blocks 1120, and 1130).

While the invention has been described in terms of several embodiments, the invention should not limited to only those embodiments described, but can be practiced with modification and alteration within the spirit and scope of the appended claims. The description is thus to be regarded as illustrative instead of limiting.

What is claimed is:

1. An integrated circuit device comprising:
an interconnect;
at least one compute engine coupled to the interconnect; and
a control unit coupled to the at least one compute engine and the interconnect, the control unit to control an energy-efficient operating setting for the integrated circuit device by analyzing heuristic information from the at least one compute engine and to increase a bandwidth of the interconnect based on the heuristic information.

2. The integrated circuit device of claim 1, wherein the interconnect is a ring interconnect traversing at least two power planes.

3. The integrated circuit device of claim 2, wherein the control unit to increase an operating frequency of the ring interconnect if the heuristic information identifies that the at least one compute engine is memory bound.

4. The integrated circuit device of claim 2, wherein the at least one compute engine includes a processor compute engine including at least one processor core and a graphics compute engine including at least graphics logic.

5. The integrated circuit device of claim 4, wherein the control unit to decrease an operating frequency of the ring interconnect if the heuristic information identifies that both at least one processor core and the graphics logic have a workload lower than a predetermined level and are not memory bound.

6. The integrated circuit device of claim 4, wherein the control unit is located on a first power plane, the at least one processor core is located on a second power plane, and the graphics logic is located on a third power plane.

7. The integrated circuit device of claim 2, wherein the control unit is a system agent positioned on a different power plane than the at least one compute engine, the system agent includes a micro-controller that controls an application of voltage and frequency to the ring interconnect based on the heuristic information.

8. An electronic device comprising:
a first interconnect;
a memory subsystem coupled to the first interconnect, the memory subsystem including at least one of a double data rate random access memory and synchronous dynamic random access memory; and
a processor coupled to the memory subsystem via the first interconnect, the processor including
a second interconnect,
at least one compute engine coupled to the second interconnect, and
a control unit coupled to the at least one compute engine and the second interconnect, the control unit to control an energy-efficient operating setting for the integrated circuit device by analyzing heuristic information from the at least one compute engine and to alter performance of the system memory based on the heuristic information.

9. The electronic device of claim 8, wherein the control unit of the integrated circuit device to decrease a frequency of the system memory based on the heuristic information.

10. The electronic device of claim 8, wherein the control unit of the integrated circuit device to decrease a number of memory channels associated with the first interconnect based on the heuristic information.

11. The electronic device of claim 8, wherein the control unit of the integrated circuit device is a system agent positioned on a different power plane than the at least one compute engine of the integrated circuit device, the system agent includes a micro-controller that runs firmware for controlling performance of the system memory and bandwidth constraints of the second interconnect.

12. The electronic device of claim 8, wherein the control unit of the integrated circuit device to increase an operating frequency of the second interconnect if the heuristic information identifies that the at least one compute engine is memory bound.

13. The electronic device of claim 14, wherein the control unit of the integrated circuit device to decrease an operating frequency of the second interconnect if the heuristic information identifies that both at least one processor core and graphics logic of the at least one compute engine have a workload less than a predetermined level and are not memory bound.

14. A method for efficient energy consumption comprising:
receiving heuristic information from at least one compute engine;
analyzing the heuristic information to determine, in a dynamic manner, if an operating characteristic of a targeted subsystem should be altered; and
altering the operating characteristic of the target subsystem based on the heuristic information.

15. The method of claim 14, wherein the targeted subsystem is one of a memory subsystem and an input/output (I/O) subsystem.

16. The method of claim 15, wherein the operating characteristic is a bandwidth of an interconnect being part of the I/O subsystem.

17. The method of claim 15, wherein the operating characteristic is one of (1) a size and an operating frequency used by a cache memory within the memory subsystem and (2) a number of channels supported by an interconnect coupling the memory subsystem.

18. The method of claim 15, wherein the operating characteristic is a number of channels supported by an interconnect coupling the memory subsystem.

19. The method of claim 15, wherein the at least one compute engine includes at least one processor core situated in a first power plane within an integrated circuit device and a graphics logic situated in a second power plane within the integrated circuit device.
